(19) United States
(12) Patent Application Publication
(10) Pub. No.: US 2026/0141363 A1
(43) Pub. Date: May 21, 2026

(54) SYSTEMS AND METHODS FOR VERIFIABLE PHYSICAL EMBLEM-ANCHORED DOMAIN-BASEPOINT SERVICE DISCOVERY AND POLICY-GATED ISSUANCE OF BEIDID AND TIME-DENOMINATED ASSETS

(71) Applicant: FURONG BEI, SAN GABRIEL, CA (US)

(72) Inventor: FURONG BEI, SAN GABRIEL, CA (US)

(21) Appl. No.: 19/439,418

(22) Filed: Jan. 4, 2026

Related U.S. Application Data
(63) Continuation-in-part of application No. 19/056,745, filed on Feb. 19, 2025.

(51) Int. Cl. G06Q 20/06

(52) U.S. Cl. CPC G06Q 20/065

(57) ABSTRACT

A terminal device captures an image of a verifiable physical emblem bearing an optically decodable texture code encoding an EmblemIndex and emblem identifier (EID). The terminal decodes the EmblemIndex, computes an authenticity score from anti-counterfeit optical features, resolves the EID to a domain basepoint identifier, retrieves a signed endpoint record (SER), and verifies the SER signature and time window. The terminal generates a nonce and verifies a wallet signature over a canonical message satisfying SER nonce rules to prevent replay. Policy fragments are merged across namespace scopes using constrained overrides to obtain an effective policy configuration. When gating conditions are satisfied, a policy-gated operation issues a BEIDID and/or time-denominated digital assets (TimeCurrency) or releases an execution permit for a computation function. A tamper-evident receipt with a hash anchor is produced for audit and rollback and may be reconciled by a settlement gateway.

### CROSS-REFERENCE TO RELATED APPLICATIONS

This application is a continuation-in-part of the U.S. application Ser. No. 19/056,745, filed Feb. 19, 2025, the entirety of which is incorporated herein by reference to the extent not inconsistent with the present disclosure.

### RELATED APPLICATIONS (NON-PRIORITY; NON-BENEFIT)

U.S. application Ser. No. 19/183,053, filed Apr. 18, 2025 (Confirmation No. 4477), titled “Navigation & Telecommunications Integration Module for TimeCurrency Ecosystem,” is identified as a related application for technical background and ecosystem context only.

### TECHNICAL FIELD

Embodiments relate to verifiable physical objects, optical feature decoding, cryptographic service discovery, decentralized identifiers, time-window gating, policy controlled issuance, and tamper-evident audit trails.

### BACKGROUND

Conventional machine-readable symbols (e.g., barcodes and QR codes) may be captured and replayed using photographs or screenshots. Many identity, loyalty, and activity-credit systems are centralized, opaque, and vulnerable to phishing, replay, and counterfeit inputs. Existing decentralized identity and token systems often lack practical physical anchoring, fine-grained time-window controls, and auditable receipts suitable for dispute handling.

Further, user friction and privacy risk increase when systems mandate native app installation, biometric collection (e.g., face or fingerprint), or government identity verification. Accordingly, a technical need exists for a physical-to-digital entry mechanism that resists photographic reproduction, supports decentralized service discovery anchored to a human-readable domain basepoint, enforces time-window gating and anti-replay authentication, and produces tamper-evident receipts while enabling privacy-preserving, minimal-disclosure operation.

### SUMMARY

This disclosure provides a verifiable physical emblem that encodes a public EmblemIndex in a double-helix texture code, and a terminal process that: (i) decodes the EmblemIndex locally, (ii) computes an authenticity score using anti-counterfeit features, (iii) resolves a domain basepoint identifier associated with an EmblemID (EID) to obtain a Signed Endpoint Record (SER), (iv) verifies a signature and an effective time window of the SER, (v) performs anti-replay challenge-response wallet authentication, (vi) computes an effective policy configuration via deterministic policy inheritance across namespace scopes, (vii) executes policy-gated issuance of a Behavioral Economics Identity identifier (BEIDID) and time-denominated digital assets (TimeCurrency) subject to rate limits and per-epoch caps, and (viii) outputs a tamper-evident receipt anchored by a hash for auditing and rollback dispute handling.

In preferred embodiments, the terminal is a browser-based client (no native app required), and the system operates without collecting biometric identifiers and without requiring government identity verification, using wallet signatures and minimal-disclosure commitments for privacy-preserving operation.

### BRIEF DESCRIPTION OF THE DRAWINGS

FIG. 1 is a block diagram of an example decentralized system 100 including a verifiable physical emblem 110, a terminal device 120, a domain basepoint 130, a signed endpoint record (SER) 140, a policy manifest 150, a wallet 160, a policy-gated issuance engine 170, a distributed ledger 180, and a tamper-evident receipt 190.

FIG. 2 is a schematic view of the verifiable physical emblem 110 including a substrate 112 and a double-helix texture code 114 encoding an EmblemIndex 115 comprising an EmblemID (EID) 115a, error-correction data 115b, and an authentication tag 115c, with optional anti-counterfeit microstructures 116 and a watermark ring 118.

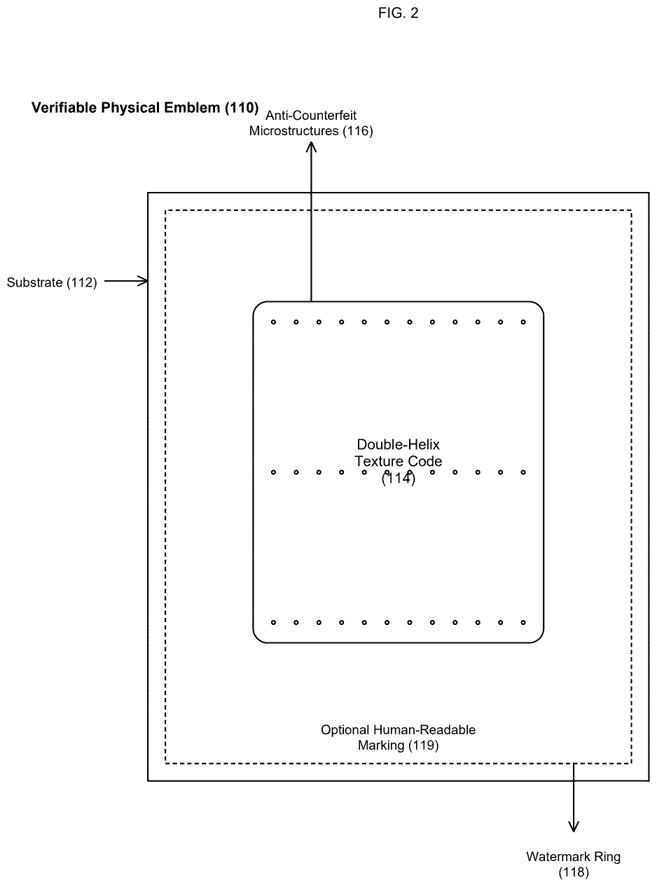

FIG. 3 is a flow/pipeline diagram of terminal-side processing by the terminal device 120 including image capture 122, decoding 124, authenticity scoring 126, domain basepoint resolution 128, SER verification 132, nonce generation 134, wallet signature verification 136, policy inheritance computation 138, and issuance/receipt generation 139.

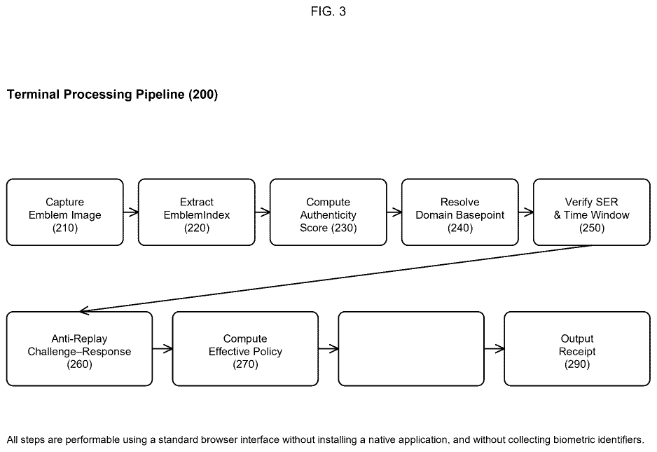

FIG. 4 is a data-structure diagram of an example SER 140 including fields such as a version field 141, ser_id 142, domain_basepoint 143, public_key 144, effective_time_window 145, endpoint_descriptor 146, policy_pointer 147, nonce_rules 148, issued_at 149, and a signature 140s.

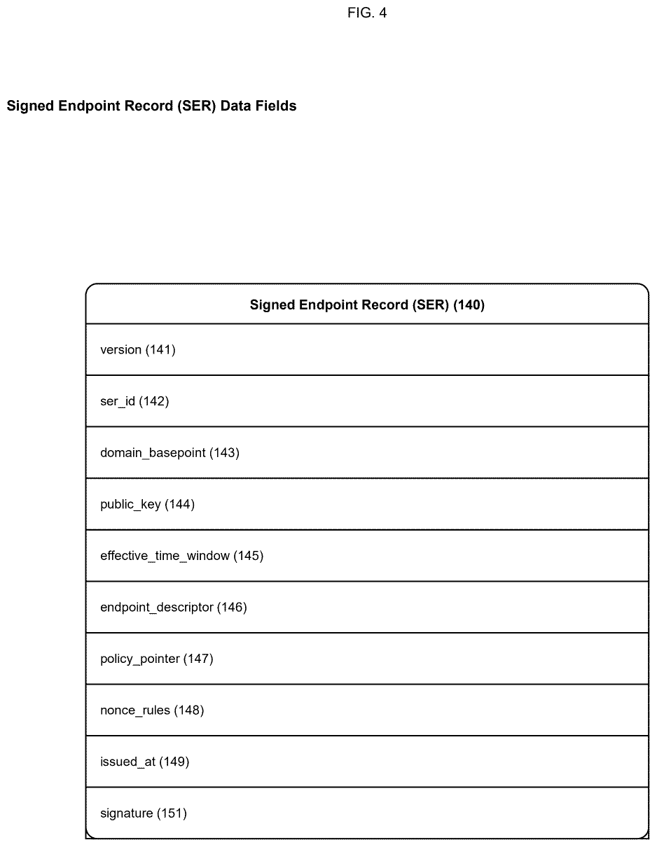

FIG. 5 is a diagram of policy inheritance across hierarchical namespace scopes, including a root policy fragment 150a, a domain policy fragment 150b, a scene/object policy fragment 150c, and a user policy fragment 150d that are deterministically merged by a merge function 152 to produce an effective policy configuration 154 subject to constraints 156.

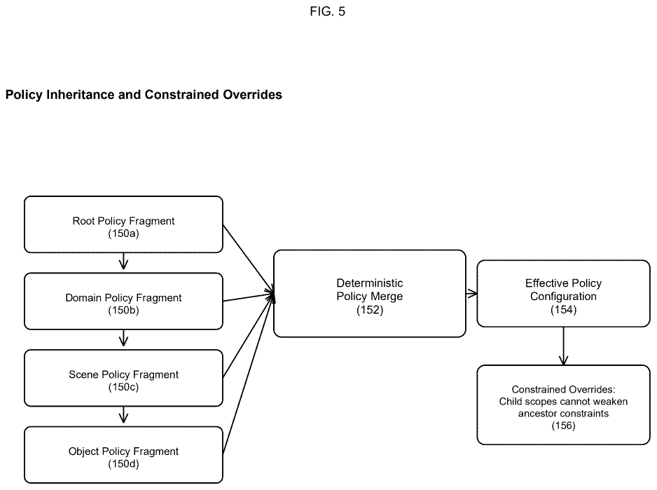

FIG. 6 is a flowchart of time-window gating and anti-replay authentication including steps of emblem capture 202, EmblemIndex extraction 204, SER retrieval 206, SER signature and time-window verification 208, nonce generation 210, wallet signature 212, anti-replay verification 214, effective policy computation 216, policy-gated issuance 218, and receipt anchoring 220.

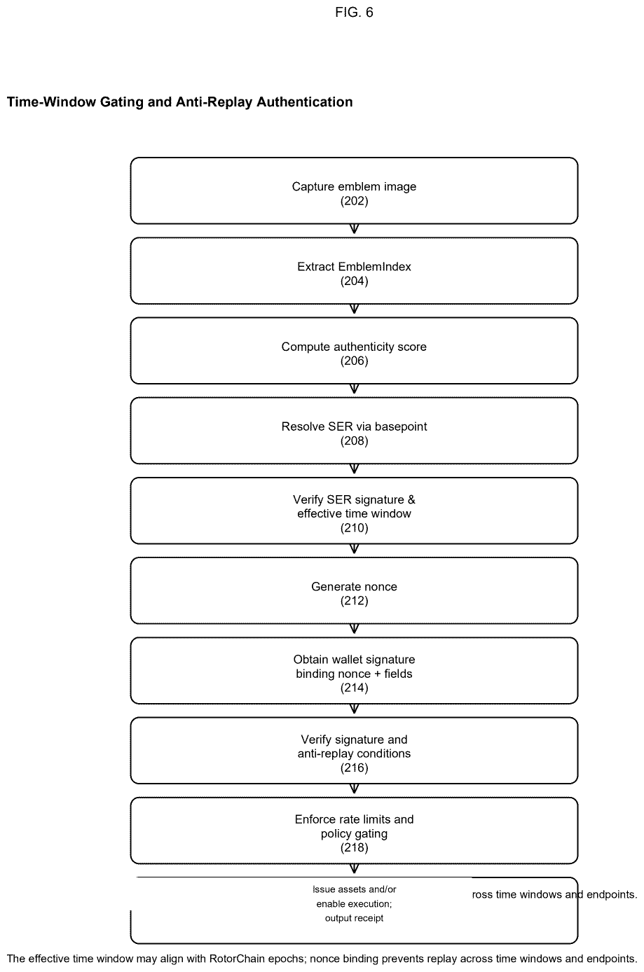

FIG. 7 is a diagram of a tamper-evident receipt 190 including fields such as receipt_id 191, EID 192, time_window_id 193, policy_id 194, consumption_counter 195, hash_anchor 196, and links to an audit module 197 and rollback module 198 anchored to the distributed ledger 180.

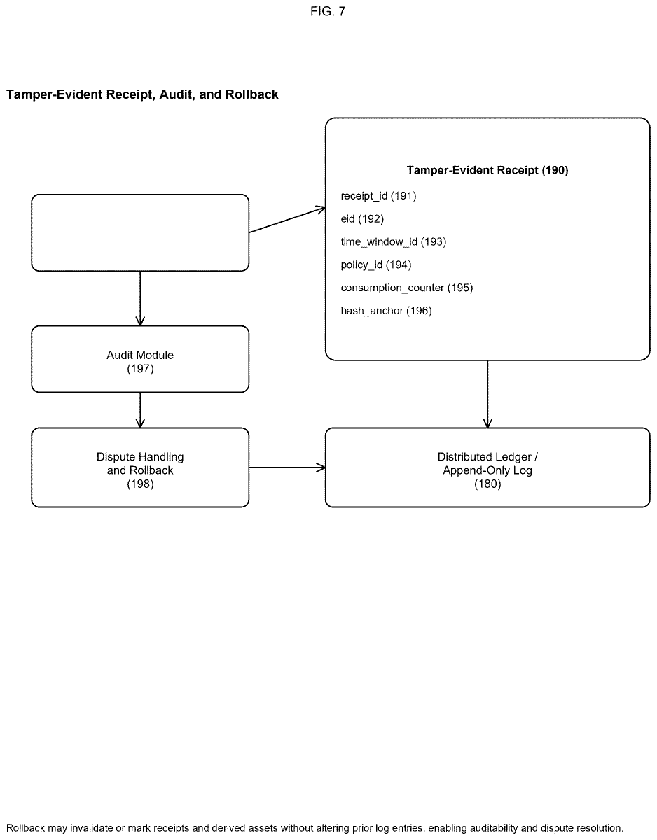

### REFERENCE NUMERALS

100 System
110 Verifiable physical emblem
112 Substrate
114 Double-helix texture code
115 EmblemIndex
115a EmblemID (EID)
115b Error-correction data
(ECC) 115c Authentication tag
116 Anti-counterfeit microstructures
118 Watermark ring (optional)
120 Terminal device
122 Image capture module
124 Decoder
126 Authenticity scoring module
128 Domain basepoint resolver
130 Domain basepoint
132 SER verification module
134 Nonce generator
136 Wallet signature verification module
138 Policy inheritance engine
139 Execution/issuance and receipt
generator 140 Signed endpoint record
(SER) 145 Effective time window
150 Policy manifest/policy fragments
160 Wallet
170 Policy-gated execution/issuance engine
180 Distributed ledger/append-only log
190 Tamper-evident receipt

### DETAILED DESCRIPTION-DEFINITIONS

To ensure clarity and definiteness under 35 U.S.C. § 112, the following terms are used consistently throughout this specification and the claims. Where appropriate, meanings are aligned with related Signed Endpoint Record (SER) formats, PolicyGated controls, time-window mechanisms (including epoch identifiers), and routing/manifest patterns used in distributed systems.

Behavioral Economics Identity identifier (BEIDID): A decentralized identifier representing a user's behavioral economics identity, bound to a wallet-controlled cryptographic key pair. The BEIDID is issued as a verifiable credential or soulbound token following successful emblem authentication and policy-gated gating, and serves as a persistent reference for TimeCurrency accrual and receipt auditing. The BEIDID is distinct from the EmblemID (EID) and is generated only after challenge-response authentication.

Time-denominated digital asset (TimeCurrency): A digital asset representing accrued units of value denominated in time-based increments, subject to policy-gated issuance, time-window constraints, rate limiting, and epoch-bounded enhancement. TimeCurrency is minted in increments based on verified events and recorded in tamper-evident receipts, enabling applications such as service redemption or governance participation without promising monetary returns.

Verifiable physical emblem: A physical object (e.g., card, badge, label, or bearer item) incorporating a double-helix texture code as a machine-readable feature for initiating the claimed processes. The emblem is designed for resistance to counterfeiting and photographic reproduction through microstructures, watermarks, or diffractive elements.

Double-helix texture code: A visual encoding pattern resembling a DNA double helix, comprising base-pair-like elements that encode the EmblemIndex. The code incorporates error-correction data (ECC) for robustness and anti-counterfeit features (e.g., illumination-variant microstructures) detectable by terminal processing.

EmblemIndex: A structured data payload encoded in the double-helix texture code, comprising at least an EmblemID (EID), version field, error-correction data (ECC), and authentication tag. The EmblemIndex serves as a public, non-secret index for domain basepoint resolution and local authenticity scoring, and is distinct from private key material or the resulting BEIDID.

EmblemID (EID): A unique public identifier within the EmblemIndex, used for domain basepoint resolution to retrieve the SER. The EID is a non-secret index derived from the physical emblem and does not contain or reveal wallet private keys.

Authenticity score: A numerical value computed locally on the terminal device by evaluating consistency between the extracted EmblemIndex and expected anti-counterfeit features (e.g., geometric models, microstructure patterns, or watermark integrity), used as a gating threshold to prevent processing of counterfeit emblems. Domain basepoint identifier: A human-readable identifier (e.g., a domain name) associated with the EID, resolved via standard protocols (e.g., DNS and HTTPS retrieval) to retrieve the Signed Endpoint Record (SER). The domain basepoint serves as a trust anchor for decentralized service discovery.

Signed Endpoint Record (SER): A cryptographically signed data structure retrieved via domain basepoint resolution, comprising at least a public key, endpoint descriptor, effective time window, and digital signature. The SER may further include ser_id, issued_at timestamp, nonce_rules, and policy pointer, and supports time-window gating and emblem-triggered flows.

Effective time window: A validity period defined in the SER (e.g., start and end timestamps), enforced by the terminal to prevent use of expired or future-dated records, and compatible with epoch-based window identifiers.

Anti-replay challenge-response authentication: A cryptographic protocol where the terminal generates a nonce, the user's wallet signs a message incorporating the nonce (and optionally bound fields per nonce_rules), and the signature is verified to ensure freshness and prevent replay attacks.

Policy inheritance rules: Deterministic rules for merging policy fragments across hierarchical namespace scopes, with constrained overrides preventing weakening of ancestor constraints.

Policy-gated issuance: Controlled generation of BEIDID and TimeCurrency increments, executed only when gating conditions (e.g., authenticity score, SER validity, authentication success, rate limits) are satisfied.

Tamper-evident receipt: A data structure output after issuance, comprising at least EID, a time-window identifier, a policy identifier, a consumption counter, and a hash anchor (e.g., Merkle commitment or distributed ledger reference), supporting auditing, dispute resolution, and rollback without revealing raw attributes.

Minimal-disclosure commitment: A privacy-preserving technique (e.g., salted hash commitment or zero-knowledge proof) used to submit evidence of events without disclosing underlying attributes.

Execution permit: A short-lived capability, credential, or wrapped key released under policy control that authorizes a terminal device, agent, or service to perform a protected computation function within a bounded time window and scope, optionally comprising a session token, a session key, a wrapped model-decryption key, or a remote-attestation allowance.

Protected computation function: A gated computational operation whose execution is authorized by an execution permit and constrained by the effective policy configuration, including, by way of example, private machine-learning model inference, confidential data processing, controlled tool invocation, secure media generation, or metered service execution.

Global Name Service (GNS): A directory service or signed mapping that associates an EID or an EID prefix with a domain basepoint identifier to support scalable discovery and routing, while preserving the EID as a public, non-secret index.

### DETAILED DESCRIPTION—SYSTEM OVERVIEW

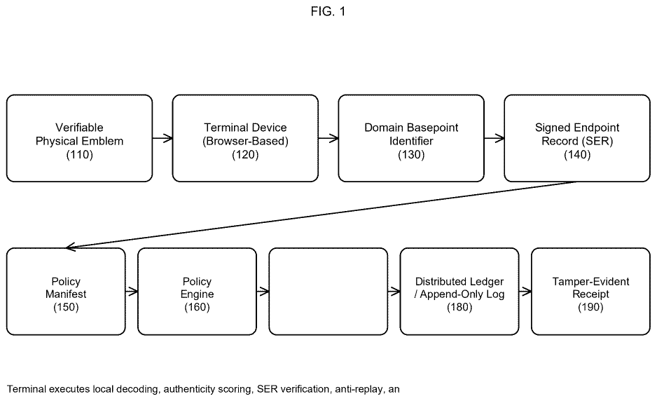

Referring to FIG. 1, the decentralized system 100 includes the verifiable physical emblem 110 and the terminal device 120. In operation, the terminal device 120 captures the double-helix texture code 114 to extract the EmblemIndex 115 including the EID 115a. The terminal device 120 resolves the domain basepoint 130 associated with the EID 115a to obtain the SER 140, verifies the SER 140 and its effective time window 145, performs

anti-replay challenge-response authentication with the wallet 160, computes an effective policy configuration from a policy manifest 150, and invokes the policy-gated issuance engine 170 to issue BEIDID and epoch-bounded TimeCurrency. The system outputs a tamper-evident receipt 190 anchored to the distributed ledger 180 for auditability and rollback dispute handling.

In one preferred deployment, the domain basepoint 130 corresponds to a root domain operated by a system issuer (e.g., “beiemb.com”), and the policy_pointer 147 in the SER 140 references a policy manifest 150 hosted at a dedicated policy domain (e.g., “beipolicy.com”), thereby enabling independent lifecycle management of policies without requiring replacement of the verifiable physical emblem 110.

In some embodiments, receipts 190 are consumed by a settlement or clearing gateway implemented as a network service (e.g., under “atms.com”) to perform automated reconciliation, redemption authorization, or governance accounting using the hash anchors recorded on the distributed ledger 180, without requiring disclosure of biometric identifiers or government identity verification.

### DETAILED DESCRIPTION-NO-APP/NO-BIOMETRICS OPERATION

In a preferred embodiment, the terminal device is a standard smartphone or browser enabled device that accesses an image sensor using a standards-based web interface (e.g., a camera API). The embodiment is performable without installing a native application. The embodiment does not require collecting biometric identifiers (e.g., fingerprint, face, iris) and does not require government identity verification. Instead, a wallet signature provides cryptographic control and user consent, and event evidence may be provided using minimal-disclosure commitments.

### Embodiment 1—Bootstrap Beidid Generation

A user presents the verifiable physical emblem to the terminal. The terminal captures one or more images and decodes the double-helix texture code to reconstruct the EmblemIndex using ECC. The terminal computes an authenticity score based on anti-counterfeit features (for example, illumination-variant microstructures) and rejects processing when the score is below a threshold.

The terminal resolves a domain basepoint identifier associated with the EID. In one example, the domain basepoint is a root domain (e.g., “beiemb.com” or “beidna.com”). In another example, the domain basepoint is a delegated subdomain representing an object or scene (e.g., “scene123.beiemb.com”). The terminal retrieves an SER, verifies the SER signature, checks the effective time window and issued_at timestamp, and enforces nonce_rules.

The terminal generates a nonce and requests a wallet signature over a canonical message that binds at least the nonce and a time-window identifier, and, in preferred embodiments, binds the domain_basepoint identifier. Upon successful verification and policy gating, the

system issues a BEIDID bound to the wallet public key. A tamper-evident receipt is generated and anchored for audit.

### Embodiment 2—Timewindow Issuance of Timecurrency

The terminal performs repeated issuance in discrete time windows (epochs). An effective policy configuration is computed by deterministic inheritance across namespace scopes. For example, a global policy at the root domain defines base security constraints and global caps; a scene policy at a subdomain defines a local issuance rate; and a user policy at a BEIDID scope defines optional preferences while not weakening ancestor constraints.

When gating conditions are satisfied (authenticity score threshold, SER validity, anti replay authentication, and rate limits), the system issues TimeCurrency increments for the current time window and records a consumption counter to prevent repeated reuse within the epoch. Evidence of qualifying events may be submitted as minimal-disclosure commitments (e.g., salted hashes of event attributes) so that raw attributes are not disclosed in the receipt.

### Embodiment 3-Object/Scene Binding (IOT Terminalization)

In one embodiment, the emblem is affixed to or associated with a physical object, location, or scene. The EID resolves to a domain basepoint scope representing the object/scene, enabling a policy fragment tailored to that context. Example contexts include transit entry, merchant redemption, workplace task check-ins, device provisioning, and community check-ins. The binding to an object/scene is achieved through namespace scoping and policy gating, without biometrics and without mandatory native application installation.

### Embodiment 4-Optional Recovery Mode (Pin/Card Export)

In an optional recovery mode, the system permits a user-selected short PIN (e.g., 4 digits) used only for local encryption of exported BEIDID card material. The PIN is optional and may be skipped. Recovery does not require biometrics and does not require centralized identity verification.

### Interoperability and Standards Alignment

Implementations may interoperate with existing standards and legal frameworks by using domain name resolution (DNS), HTTPS, and JSON-based documents for SER 140 and policy manifests 150; RFC 3339/ISO 8601 timestamps for effective time windows 145; W3C Decentralized Identifiers (DIDs) and verifiable credentials for BEIDID representations; and standard digital signature formats (e.g., ECDSA/Ed25519) for SER and wallet signatures. Where desired, receipts 190 may be mapped to external accounting or payment message formats (e.g., ISO 20022) for enterprise reconciliation, without altering the core policy-gated issuance and privacy-preserving commitments described herein.

### Appendix—Implementation Data Structures, Policy Examples, and Web-Based Terminal Operation

This Appendix is provided as an illustrative, non-limiting disclosure to support enablement and definiteness under 35 U.S.C. § 112. Equivalent encodings, transport mechanisms, and cryptographic suites may be used without departing from the claimed invention.

### Embodiment 5-Policy-Gated Unlocking of Private AI Models (Hybrid Cloud/Edge)

In some embodiments, the policy-gated issuance described herein is implemented as policy gated enabling of a protected computation environment, including a private machine-learning model inference runtime, a local model execution service, or a confidential data processing toolchain. The protected computation function is performed only when gating conditions are satisfied, including (i) an authenticity score meeting a threshold, (ii) SER signature verification and effective time-window validation, and (iii) anti-replay challenge-response wallet authentication enforcing nonce_rules.

In an illustrative flow, a terminal device captures an emblem image, decodes the EmblemIndex, and computes an authenticity score. The terminal resolves a domain basepoint identifier to retrieve a Signed Endpoint Record (SER) and verifies the SER signature and effective time window. The terminal generates a nonce and requests a wallet signature over a canonical message binding at least the nonce and a time-window identifier, and optionally binding the domain basepoint identifier, in accordance with nonce_rules. Upon successful verification, the terminal computes an effective policy configuration via deterministic inheritance across namespace scopes.

When the effective policy configuration authorizes execution, the system releases an execution permit for the protected computation environment. The execution permit may comprise a short-lived capability token, a session key, a wrapped model-decryption key, a remote attestation allowance, or an authorization to load protected resources into a trusted execution environment. The permit is constrained by policy parameters including rate limits, per-epoch caps, allowed tools, allowed data scopes, allowed network egress, and audit requirements. A tamper-evident receipt is generated that includes at least the EID, time-window identifier, policy identifier, and a hash anchor for later auditing and rollback dispute handling, without revealing raw private-model inputs.

### Embodiment 6-Industrial Robot and Object-Node Audit (Machine Work Receipts)

In some embodiments, the emblem is associated with an object, device, workstation, location, or industrial scene (an “Object Node”), and a machine controller (including a robot controller or edge gateway) acts as the terminal device. The EID resolves to a domain basepoint scope representing the Object Node, and a policy fragment tailored to the industrial context is inherited and merged into the effective policy configuration.

In an illustrative implementation, each completed machine action or work-step (e.g., pick, place, weld, inspect, transport, verify, or calibrate) triggers a policy-gated event. The terminal binds the event to an object identifier and a scene descriptor, enforces the time-window gating and anti-replay authentication, and generates a tamper-evident receipt. The receipt may represent a verifiable work ticket or process proof for compliance, traceability, and reconciliation, and may be anchored to a distributed ledger or enterprise audit log using a hash anchor. The effective policy configuration may require minimal-disclosure commitments so that sensitive production attributes are not revealed in the receipt while remaining verifiable for disputes.

### Embodiment 7-Agent-to-Agent Service Invocation and Settlement (Agentic AI)

In some embodiments, software agents (“Agents”) discover, authenticate, and invoke services using the same domain-basepoint and SER mechanisms described herein. An Agent may resolve a counterparty Agent's domain basepoint using a directory service or a signed mapping, retrieve the counterparty SER, validate the SER signature and effective time window, and perform nonce-based challenge-response authentication using a wallet or service key under nonce_rules.

A policy_pointer in the SER may reference a policy manifest that declares terms of service invocation, including permitted methods, quotas, pricing schedules, and settlement endpoints. The invoking Agent computes an effective policy configuration by deterministic inheritance across namespace scopes (e.g., root policy, industry policy, scene policy, and agent policy), and executes a policy-gated invocation only when gating conditions are satisfied. A tamper-evident receipt is produced for each invocation and may encode time-denominated usage, compute denominated usage, or other metered consumption, enabling dispute handling and reconciliation. Settlement may be performed via an optional clearing and settlement gateway, without constraining the claims to a specific payment platform.

APPENDIX A-DATA STRUCTURES (CANONICAL FORMS) In preferred embodiments, the terminal device exchanges compact, cryptographically verifiable data structures. Implementations may use JSON, CBOR, or another canonical serialization. Unless otherwise stated, signatures are computed over a canonicalized byte representation excluding the signature field itself.

A-1. EmblemIndex (E-Index) Encoded in Double-Helix Texture Code The EmblemIndex is a public, non-secret payload encoded in the double-helix texture code on the verifiable physical emblem. It is extracted locally by the terminal device and used for (i) local authenticity scoring and (ii) domain-basepoint service discovery.

| Field | Type | Required | Description |
|---|---|---|---|
| eid | string | Yes | EmblemID |
| | | | (EID), a unique |
| | | | public |
| | | | identifier used |
| | | | for domain |
| | | | basepoint |
| | | | resolution. |
| version | string | Yes | Protocol/version |
| | | | field for forward |
| | | | compatibility |
| | | | (e.g., “1.0”). |
| ecc | bytes | Yes | Error-correction |
| | | | codewords |
| | | | enabling |
| | | | recovery under |
| | | | partial |
| | | | occlusion/damage. |
| auth_tag | bytes | Yes | Authentication |
| | | | tag used for |
| | | | local |
| | | | consistency |
| | | | checks and |
| | | | authenticity |
| | | | scoring. |
| time hint | string | No | Optional hint |
| | | | (e.g., |
| | | | epoch/window |
| | | | label) aligned |
| | | | with SER |
| | | | effective time |
| | | | window. |
| basepoint_hint | string | No | Optional human |
| | | | readable |
| | | | domain |
| | | | basepoint hint; |
| | | | if omitted, the |
| | | | basepoint may |
| | | | be resolved via |
| | | | a |
| | | | directory or |
| | | | namespace rule. |

Example (JSON form for illustration only):

{ “eid”:“emb-2026-000123”, “version”:“1.0”,
“ecc”:“BASE64:ECCDATA”, “auth_tag”:“BASE64:AUTHTAG”,
“time_hint”:“EPOCH-2026-01” }

### A-2. Signed Endpoint Record (SER)

A Signed Endpoint Record (SER) is retrieved by resolving a domain basepoint identifier associated with the EID. The SER provides a signed configuration for endpoints, public keys, time windows, policy pointers, and nonce binding rules. SER rotation and revocation are supported via ser_id and issued_at.

| Field | Type | Required | Description |
|---|---|---|---|
| version | string | Yes | SER format |
| | | | version. |
| ser_id | string | Yes | Unique |
| | | | identifier for |
| | | | the SER |
| | | | instance |
| | | | (supports |
| | | | rotation/ |
| | | | revocation/audit). |
| | | | Domain |
| | | | basepoint trust |
| | | | anchor (e.g., |
| | | | “beiemb.com”). |
| public_key | object/string | Yes | Public key used |
| | | | to verify the |
| | | | SER |
| | | | signature (e.g., |
| | | | Ed25519 or |
| | | | ECDSA). |
| effective_time | object | Yes | Validity window: |
| win dow | | | { “start”: |
| | | | RFC3339, “end” |
| | | | RFC3339 }. |
| endpoint_descriptor | object/string | Yes | One or more |
| | | | endpoints (e.g., |
| | | | issuance, query, |
| | | | receipt |
| | | | verification). |
| policy_pointer | string | Yes | Pointer |
| | | | (URL/URI) to a |
| | | | policy manifest |
| | | | or policy |
| | | | fragment set. |
| nonce rules | object | Yes | Rules requiring |
| | | | wallet signatures |
| | | | to bind to |
| | | | specified fields |
| | | | (anti-replay). |
| issued at | string | Yes | SER issuance |
| | | | timestamp |
| | | | (RFC3339). |
| signature | string/object | Yes | Digital signature |
| | | | over canonical |
| | | | SER payload |
| | | | (excluding |
| | | | this field). |

Example SER (JSON, illustrative):

```
  {
  “version”: “1.0”,
  “ser_id”: “ser-3f2c7b1e-9a10-4b6b-8a61-7b6f0d0d7a21”,
  “domain_basepoint”: “beiemb.com”,
  “public_key”: { “kty”:“OKP”, “crv”:“Ed25519”,
  “x”:“BASE64URL:PUBLICKEY” },
“effective_time_window”: { “start”:“2026-01-01T00:00:00Z”,
“end”:“2030-12-31T23:59:59Z” },
  “endpoint_descriptor”: {
  “issue”: “https://api.beiemb.com/v1/issue”,
  “query”: “https://api.beiemb.com/v1/query”
  },
  “policy_pointer”: “https://beipolicy.com/v1/policies/root.json”,
  “nonce_rules”: {
  “format”: “BEI-SIGN-V1”,
  “must_bind”: [“nonce”, “domain_basepoint”, “ser_id”,
“time_window_id”] },
  “issued_at”: “2026-01-03T00:00:00Z”,
  “signature”: “BASE64URL:SIGNATURE”
  }
```

### A-3. Policy Manifest (PolicyGated Controis)

Policy manifests define gating conditions, rate limits, and inheritance/override rules. A policy may be scoped at multiple namespace levels (e.g., root domain, subdomain for industry, subdomain for scene/location) and deterministically merged to form an effective policy configuration.

| Field | Type | Required | Description |
|---|---|---|---|
| policy_id | string | Yes | Unique policy |
| | | | identifier. |
| scope | string | Yes | Namespace scope |
| | | | identifier (e.g., |
| | | | root, industry, |
| | | | scene). |
| inheritance_rules | object | Yes | Precedence and |
| | | | constrained |
| | | | override rules; |
| | | | children cannot |
| | | | weaken |
| | | | ancestor |
| | | | constraints. |
| gating_conditions | array | Yes | Required |
| | | | checks (e.g., |
| | | | authenticity |
| | | | threshold, SER |
| | | | validity, nonce |
| | | | verification, |
| | | | rate limits). |
| rate_limits | object | Yes | Caps and |
| | | | quotas (per |
| | | | epoch/day/window). |
| issuance_formula | object/string | No | Deterministic |
| | | | function |
| | | | parameters (e.g., |
| | | | pulse function |
| | | | coefficients) |
| | | | subject to caps. |
| privacy_rules | object | No | Minimal- |
| | | | disclosure |
| | | | requirements |
| | | | (e.g., salted hash |
| | | | commitments; |
| | | | optional ZK |
| | | | proofs). |

### A-4. Tamper-Evident Receipt

After a policy-gated issuance event, the system outputs a tamper-evident receipt. The receipt supports auditing and rollback dispute handling without requiring disclosure of raw behavioral attributes.

| Field | Type | Required | Description |
|---|---|---|---|
| receipt_id | string | Yes | Unique receipt |
| | | | identifier. |
| eid | string | Yes | EID that |
| | | | triggered the |
| | | | event. |
| beidid_ref | string | No | Reference to |
| | | | issued BEIDID |
| | | | (may be hashed |
| | | | for privacy). |
| time_window_id | string | Yes | Epoch/window |
| | | | identifier used |
| | | | for gating and |
| | | | rate |
| | | | limiting. |
| policy_id | string | Yes | Applied |
| | | | effective |
| | | | policy |
| | | | identifier. |
| timecurrency_delta | integer | Yes | Issued |
| | | | TimeCurrency |
| | | | increment |
| | | | (bounded). |
| consumption_counter | integer | Yes | Anti-reuse counter |
| | | | for the issuance |
| | | | attempt within |
| | | | the window. |
| commitment | string | No | Minimal- |
| | | | disclosure |
| | | | commitment |
| | | | (e.g., salted |
| | | | hash) to |
| | | | event evidence. |
| hash_anchor | string | Yes | Anchor (Merkle |
| | | | root, ledger tx |
| | | | hash, or append- |
| | | | only log hash). |
| timestamp | string | Yes | Receipt |
| | | | issuance |
| | | | timestamp |
| | | | (RFC3339). |

APPENDIX B—POLICY INHERITANCE AND RATE-LIMITED ISSUANCE In preferred embodiments, policy fragments are defined at hierarchical namespace scopes and deterministically merged. Constrained overrides prevent descendant scopes from weakening security, privacy, or rate-limit constraints established by ancestors.

### B-1. Example Hierarchy and Deterministic Merge

A root scope may define minimum authenticity thresholds, required nonce bindings, and global caps. An industry scope may define additional gating conditions relevant to a sector (e.g., logistics, healthcare, retail). A scene/location scope may define contextual caps (e.g., per-location quota) while inheriting the root security constraints.

### B-2. Rate Limiting and Inflation Control

The effective policy configuration may include epoch-based caps, per-wallet caps, and per-EID caps. Issuance attempts within an epoch may be tracked via a consumption counter or spend-notice record, preventing double-use within the same window.

### B-3. Privacy and No-Biometrics Baseline

Policies may expressly forbid collection of biometric identifiers and government identity verification. Event evidence may be provided as minimal-disclosure commitments (e.g., salted hashes) or zero-knowledge proofs. Raw geolocation coordinates and raw physiological signals need not be stored; implementations may store only discretized or committed forms.

Appendix C-Terminal Operation without Native Application (A/B Modes)

In preferred embodiments, the terminal operates via a standard browser-based client capable of camera access through web interfaces. A native application is not required.

C-1. Mode A (No-App, Na-Account. No-Biometrics)

In Mode A, a user may (i) open a web page associated with a domain basepoint, (ii) capture an emblem image, (iii) perform local extraction and authenticity scoring, (iv) retrieve and verify the SER, and (v) complete a nonce-based wallet signature. Mode A may avoid persistent accounts and may issue receipts that are verifiable without revealing personal identity.

### C-2. Mode B (Still Simple: Recoverable)

In Mode B, the user may optionally set a short PIN (e.g., 4 digits) solely for local device recovery and export a recovery card. The recovery card may encode a public recovery identifier and instructions for regenerating the wallet binding, without storing private keys on the emblem.

### C-3. Object/IoT and Scene Binding

In some embodiments, the emblem is affixed to or associated with an object, device, or location (an “Object Node”). The terminal may bind the issuance event to an object identifier and a scene descriptor (e.g., merchant site, vehicle station, clinic room) via policy-defined gating, enabling Internet-of-Things deployments across industries.

### Appendix D-Interoperability and Disclosure of Protocol Conventions

The invention is compatible with established Internet and identity standards. References herein are non-limiting examples and do not restrict the claims.

### D-1. Domain and Transport

Domain basepoint resolution may use DNS (optionally DNSSEC), and transport may use HTTPS/TLS. SERs may be hosted under well-known HTTPS paths or referenced via DNS TXT records.

### D-2. Signatures and Canonicalization

SER signatures and receipt signatures may use Ed25519, ECDSA, or equivalent. Canonicalization may use JCS (JSON Canonicalization Scheme), CBOR canonical encoding, or another deterministic method to avoid signature ambiguity.

### D-3. Well-Known Resource Conventions (Illustrative)

Table D-1 lists illustrative well-known resources
that may be hosted by a domain basepoint.

| Resource | Purpose | Example Path |
|---|---|---|
| SER | Retrieve signed | /.well-known/bei/ser.json |
| | endpoint record | |
| Policy Root | Retrieve root policy | /.well- |
| | manifest | known/bei/policy/root.json |
| Keys | Publish verification | /.well-known/bei/keys.json |
| | keys/rotation metadata | |
| Directory (GNS) | Resolve EID prefixes | /.well-known/bei/gns.json |
| | or names to | |
| | basepoints | |
| | (optional) | |

### Appendix E—Optional Integrations and Applications (Illustrative, Non-Limiting)

The following examples illustrate deployment at scale across industries and financial systems. These examples are optional and do not limit the claimed invention.

### E-1. Multi-Industry Scene Policies

A domain basepoint may delegate to industry and scene subdomains (e.g., logistics, education, healthcare, energy, retail), each providing policy fragments that adjust caps, thresholds, and redemption endpoints while inheriting core security and privacy constraints.

E-2. Global Name Service (GNS) for Behavioral Economics Identity (e.g., beigns.com)

In an illustrative implementation, a global name service (GNS) is provided under a dedicated domain (e.g., “beigns.com”). The GNS may publish a signed directory mapping EID prefixes, object identifiers, or human-readable labels to domain basepoints and SER locations. This supports large-scale routing, internationalization, and resilience when the EmblemIndex omits an explicit basepoint_hint.

E-3. Policy Hosting and Versioned Governance (e.g. beipolicy.com) In an illustrative implementation, policy manifests are hosted under a dedicated policy domain (e.g., “beipolicy.com”) and referenced by SER policy_pointer fields. Policy versioning enables economics adjustments (caps, coefficients, redemption rules) without replacing physical emblems, while preserving cryptographic verifiability.

### E-4. Financial Clearing, Settlement, and Terminal Network Integration (ATMS Example)

In some implementations, TimeCurrency receipts and policy-gated issuance events are integrated with a financial clearing and settlement network. For example, a platform operated under an ATMS deployment may provide (i) exchange-rate discovery for multiple fiat currencies, (ii) merchant settlement, and (iii) banking-terminal style interfaces for end users, while the invention's core issuance gating remains controlled by the emblem, SER verification, and policies. Such integration may support cross-currency accounting (e.g., USD, EUR, CNY) and resource-indexed units, without constraining the claims to any specific platform.

E-5. Domain Portfolio as Namespace for Sovereign Parcels (Illustrative) A portfolio of domains and namespaces may be used to represent sovereign parcels, sectors, or communities (e.g., beieco.com, bei.app, beidid.com). Each namespace may host scoped SERs and policies that govern identity creation and issuance for the associated context, while maintaining interoperability through shared formats.

### E-6. Hybrid AI Private-Model Enablement (Illustrative)

In an illustrative implementation, a domain basepoint provides policy-gated enablement for private AI models executed on an AI personal computer, an enterprise private cloud, or an edge server. The system uses emblem-triggered SER verification and effective time-window gating to authorize release of an execution permit (e.g., a session token, wrapped decryption key, or attestation allowance) for initiating model inference. Policies may specify allowed tools, data scopes, egress constraints, and per-epoch caps, and receipts provide auditable proof of authorized execution without revealing raw prompts or sensitive inputs.

E-7. Generative Media Provenance and Authenticity (Illustrative) In an illustrative implementation, media outputs (including images, video, or documents) generated under a policy-gated execution permit are associated with a tamper-evident receipt and a hash anchor such that a verifier can confirm provenance, integrity, time window, and governing policy version. In some embodiments, a media verification service is hosted under a dedicated domain basepoint that publishes signed verification endpoints and policy pointers compatible with the SER and receipt formats described herein (e.g., a domain such as “beimgs.com” used as an illustrative, non-limiting example).

E-8. Enterprise Global Services and Settlement Portals (Illustrative) In an illustrative implementation, enterprise deployments expose standardized integration endpoints and dashboards under a dedicated domain basepoint to support onboarding of industrial terminals, robot controllers, and multi-agent services (e.g., a domain such as “beigsglobal.com” used as an illustrative, non-limiting example). Receipts and policy-gated events may be reconciled through optional clearing and settlement integration while maintaining emblem anchoring, SER verification, policy inheritance, and privacy-preserving commitments. In some embodiments, the clearing and settlement gateway is implemented as a large-scale terminal network and minting/clearing infrastructure (e.g., “ATMS” used as an illustrative, non-limiting example) without requiring that any claim be limited to a particular brand, platform, or financial rail.

### Appendix To Specification (Ecosystem Context; Non-Priority)

An appendix to this specification, entitled “APPENDIX TO SPECIFICATION-RELATED BEI×BEI GALAXY×ATMS×DOMAIN-BASED ECOSYSTEM FILINGS,” is submitted herewith. The appendix provides a consolidated list of related U.S. and international patent applications filed by the present inventor and/or commonly owned entities, and is incorporated herein for technical background and ecosystem context. The applications listed in the appendix may have various prosecution statuses (including pending, allowed, issued, or abandoned), but are identified to show the broader technical landscape and continuity of development of the BEI and ATMS ecosystems.

In addition, in some embodiments a further appendix to this specification may be prepared, entitled “APPENDIX-DOMAIN-NAME PORTFOLIO FOR BEI×BEI GALAXY×ATMS ECOSYSTEM.” Such an appendix, if filed in connection with this application or a related application, may set forth a portfolio list of unique, system-level domain names associated with the BEI, BEI Galaxy, ATMS, and related ecosystems. These domain names are not merely conventional web addresses; rather, in the disclosed behavioral-economics identity infrastructure they can function as ecosystem components, including at least: (a) namespaces and routing endpoints for BEI identities and YueNames; (b) digital land parcels and service nodes within a multi-layer domain fabric; and (c) anchors for material, resource, and asset flows represented in the time-ledger and tokenization mechanisms described in this specification. To the extent any such domain-name appendix is filed in connection with this application, it is incorporated herein for technical background and ecosystem context.

Except where an individual application is expressly identified in this Cross-Reference to Related Applications section and/or in the Application Data Sheet (ADS) as a priority application or domestic benefit application, applications and materials listed in any appendix or identified as “Related (non-priority)” are not relied upon for priority or for any claim of domestic benefit or foreign priority in the present application. Identification of such applications, publications, or domain names in an appendix is not an admission that any such document or material constitutes prior art to the present application.

What is claimed is:

1. A decentralized system for generating a Behavioral Economics Identity (BEIDID) and a TimeCurrency, comprising:
a verifiable physical emblem having an optically decodable texture code encoding an EmblemIndex that includes an emblem identifier (EID);
a terminal device comprising at least one processor and a camera; and
memory storing instructions that, when executed by the at least one processor, cause the terminal device to:
(a) capture an emblem image of the verifiable physical emblem;
(b) extract the EmblemIndex from the emblem image and recover at least the EID; (c) compute an authenticity score for the emblem image based on features of the optically decodable texture code;
(d) resolve the EID to obtain a domain basepoint identifier;
(e) retrieve, using the domain basepoint identifier, a signed endpoint record (SER) and verify a digital signature of the SER and an effective time window of the SER;
(f) generate a nonce, obtain a wallet signature over a canonical message satisfying nonce_rules obtained from the SER, and verify anti-replay conditions using the nonce and the wallet signature;
(g) compute an effective policy configuration by deterministic policy inheritance across a plurality of namespace scopes using policy fragments and constrained overrides; (h) responsive to satisfaction of gating conditions in the effective policy configuration, perform a policy-gated issuance operation that issues at least one of: (i) the BEIDID, (ii) the TimeCurrency, or (iii) an execution permit enabling a protected computation function; and (i) output a tamper-evident receipt bound to the policy-gated issuance operation, the tamper evident receipt including a hash anchor usable for audit and rollback dispute handling.

2. A computer-implemented method for generating a Behavioral Economics Identity (BEIDID) and a TimeCurrency, the method comprising:
(a) capturing, by a terminal device, an emblem image of a verifiable physical emblem having an optically decodable texture code;
(b) extracting an EmblemIndex from the emblem image to recover an emblem identifier (EID);
(c) computing an authenticity score based on features of the optically decodable texture code;
(d) resolving the EID to obtain a domain basepoint identifier;
(e) retrieving a signed endpoint record (SER) associated with the domain basepoint identifier and verifying a signature of the SER and an effective time window of the SER; (f) generating a nonce and verifying a wallet signature that satisfies nonce_rules obtained from the SER to prevent replay;
(g) computing an effective policy configuration by deterministic policy inheritance across namespace scopes using constrained overrides; and
(h) upon satisfaction of gating conditions, performing a policy-gated issuance operation that issues at least one of: the BEIDID, the TimeCurrency, or an execution permit enabling a protected computation function, and outputting a tamper-evident receipt anchored by a hash anchor for audit and rollback dispute handling.

3. A verifiable physical emblem configured to initiate decentralized policy-gated issuance, the emblem comprising:
a substrate;
an optically decodable texture code disposed on the substrate;
an EmblemIndex encoded by the optically decodable texture code, the EmblemIndex including an emblem identifier (EID); and
an authentication tag associated with the EmblemIndex,
wherein the verifiable physical emblem is configured such that, when captured by a terminal device, the EmblemIndex enables resolution of a domain basepoint identifier, retrieval of a signed endpoint record (SER), verification of an effective time window and anti-replay conditions, and output of a tamper-evident receipt supporting audit and rollback.

4. The system of claim 1, wherein the optically decodable texture code comprises a double-helix pattern with redundancy and error correction configured to recover the EID under partial occlusion or partial damage.

5. The system of claim 1, wherein computing the authenticity score comprises comparing microstructure or diffraction features of the optically decodable texture code against expected feature constraints and rejecting the emblem image when the authenticity score fails to satisfy a threshold.

6. The system of claim 1, wherein resolving the EID to obtain the domain basepoint identifier comprises querying a directory or Global Name Service (GNS) that maps an EID prefix to a domain basepoint, and wherein retrieving the SER comprises accessing a well-known resource under the domain basepoint identifier.

7. The system of claim 1, wherein the SER comprises at least: a public_key field, the effective time window, a policy_pointer to a policy manifest, and nonce_rules that specify fields bound into the canonical message signed by the wallet signature.

8. The system of claim 1, wherein the deterministic policy inheritance enforces constrained overrides such that a child namespace scope cannot weaken at least one security constraint of an ancestor namespace scope.

9. The system of claim 1, wherein the policy-gated issuance operation enforces at least one of a rate limit, a per-epoch cap, or a consumption counter, and wherein the execution permit, when issued, is short-lived and expires within the effective time window.

10. The system of claim 1, wherein the tamper-evident receipt includes at least: receipt_id, eid, time_window_id, policy_id, consumption_counter, and hash_anchor, and wherein the receipt is usable for automated reconciliation by a settlement or clearing gateway, and further binds a hash commitment of an artifact produced under the policy-gated issuance operation to enable tamper detection.

11. The method of claim 2, wherein extracting the EmblemIndex comprises applying dewarping and orientation normalization to the emblem image and decoding a constrained alphabet with error correction to reconstruct at least the EID.

12. The method of claim 2, wherein verifying the wallet signature comprises verifying that the canonical message binds the nonce and at least one of the domain basepoint identifier or the time_window_id in accordance with nonce_rules obtained from the SER.

13. The method of claim 2, wherein the method is performed using a standard browser interface with camera access and is performable without installing a native application.

14. The method of claim 2, wherein the method is performed without collecting biometric identifiers or government identity verification, and wherein the tamper-evident receipt stores a salted hash commitment rather than raw behavioral attributes.

15. The method of claim 2, further comprising binding the policy-gated issuance operation to an object, place, or scene context, and using the object, place, or scene context as an additional namespace scope for computing the effective policy configuration.

16. The method of claim 2, further comprising enabling recovery by issuing a recovery credential or revocation instruction under policy control, such that compromised credentials are revocable without biometric identifiers or government identity verification.

17. The emblem of claim 3, wherein the optically decodable texture code further comprises anti counterfeit microstructures or holographic features configured to increase resistance to photographic reproduction and physical tampering.

18. The emblem of claim 3, wherein the authentication tag is verifiable using a public key obtained from the SER.

19. The emblem of claim 3, wherein the EmblemIndex further includes a basepoint hint and a time-window hint aligned with the effective time window of the SER, and optionally includes a directory hint usable for GNS-assisted resolution.

20. The emblem of claim 3, further comprising a multi-language human-readable marking on the substrate, the multi-language human-readable marking being non-essential to machine decoding of the EmblemIndex.
